(19) United States
(12) Patent Application Publication
(10) Pub. No.: US 2025/0251506 A1
(43) Pub. Date: Aug. 7, 2025

(54) VEHICLE MULTI-CHANNEL RADAR DEVICE AND SYSTEM THEREOF

(71) Applicant: CUBTEK INC., Hsinchu County (TW)

(72) Inventors: Chung-Chin JIAN, Hsinchu County (TW); Ching Han TSAI, Hsinchu County (TW)

(21) Appl. No.: 18/434,729

(22) Filed: Feb. 6, 2024

(51) Int. Cl. G01S 13/58; G01S 7/35; G01S 13/931

(52) U.S. Cl. CPC G01S 13/584; G01S 7/356; G01S 13/931; G01S 2013/9318; G01S 2013/93185; G01S 2013/932

(57) ABSTRACT

A Doppler velocity estimation method using a single chirp signal includes configuring a computing device to divide the single chirp signal into a plurality of subsignals having time intervals; configuring the computing device to estimate a first phase difference between consecutive two of the subsignals when the object has a first velocity and estimate a second phase difference between consecutive two of the subsignals with the first velocity as reference when the object has a second velocity; configuring the computing device to estimate a first estimated velocity according to a slope derived from the second phase difference; configuring the computing device to estimate a number of flip of a Doppler velocity of range-Doppler FFT according to the first estimated velocity; and configuring the computing device to estimate a second estimated velocity according to the Doppler velocity of range-Doppler FFT, the first estimated velocity and the number of flip.

### BACKGROUND

### Technical Field

The present disclosure relates to a Doppler velocity estimation method and a system thereof, and a non-transitory storage medium. More particularly, the present disclosure relates to a Doppler velocity estimation method using a single chirp signal and a system thereof, and a non-transitory storage medium.

### Description of Related Art

Radar systems are generally divided into pulsed radars and continuous-wave radars according to the transmission waveform. Therein, continuous-wave radars are the earliest widely used radars in radar systems. Early continuous-wave radars detect an object within the detection range according to existing radar echo and obtain the location of the object. However, while the above-mentioned continuous-wave radars only transmits electromagnetic waves of a fixed frequency, such radars only detect the existence of the object, but the distance and relative velocity of the object cannot be acquired.

Therefore, a Frequency Modulated Continuous Wave (FMCW) radar is developed. In the application of the FMCW radar, vehicle radar is one of the main applications. The FMCW radar applies the frequency modulation method to transmit a set of electromagnetic waves whose frequency changes with time, and calculates the distance between the vehicle body and the object through the frequency difference between the transmitted electromagnetic wave and the radar echo.

The principle of a conventional velocity estimation method of FMCW is to emit two consecutive chirps. If there is a relative Doppler velocity between the object and the radar device, there will be a phase difference between the two consecutive chirps due to a Doppler frequency shift. The phase difference is linearly proportional to the velocity of the object. However, since the Doppler phase of range-Doppler Fast Fourier Transform (FFT) can only be limited to [−π: π], it can only correspond to the velocity range [−vₘₐₓ:vₘₐₓ], where vₘₐₓ is a maximum unambiguous velocity. When the velocity of the object exceeds the maximum unambiguous velocity, the Doppler velocity of range-Doppler FFT will flip. The faster the velocity is, the larger the number of flip is. In order to solve the problem of ambiguous velocity, in one conventional technology, the principle of Chinese Remainder Theorem (CRT) is used to estimate the number of flip of the Doppler velocity of range-Doppler FFT, thereby solving the correct velocity of the object.

### SUMMARY

According to one aspect of the present disclosure, a Doppler velocity estimation method using a single chirp signal includes performing a radar signal processing step. The radar signal processing step includes configuring a radar device to receive the single chirp signal that represents a radar return received from an object around the radar device; configuring a computing device to divide the single chirp signal into a plurality of subsignals having a plurality of time intervals; configuring the computing device to estimate a first phase difference between consecutive two of the subsignals when the object has a first velocity and estimate a second phase difference between consecutive two of the subsignals with the first velocity as reference when the object has a second velocity; and configuring the computing device to estimate a first estimated velocity according to a slope derived from the second phase difference.

According to another aspect of the present disclosure, a Doppler velocity estimation system using a single chirp signal includes a radar device and a computing device. The radar device is configured to receive the single chirp signal that represents a radar return received from an object around the radar device. The computing device is signally connected to the radar device and includes a memory and a processor. The memory stores a Doppler velocity of range-Doppler Fast Fourier Transform (FFT). The Doppler velocity has a number of flip. The processor is signally connected to the memory and configured to perform a Doppler velocity estimation method. The Doppler velocity estimation method includes performing a radar signal processing step. The radar signal processing step includes dividing the single chirp signal into a plurality of subsignals having a plurality of time intervals; estimating a first phase difference between consecutive two of the subsignals when the object has a first velocity and estimating a second phase difference between consecutive two of the subsignals with the first velocity as reference when the object has a second velocity; and estimating a first estimated velocity according to a slope derived from the second phase difference.

According to further another aspect of the present disclosure, a non-transitory storage medium has instructions therein, when executed, causing a processor to perform a Doppler velocity estimation method using a single chirp signal. The Doppler velocity estimation method includes performing a radar signal processing step. The radar signal processing step includes dividing the single chirp signal into a plurality of subsignals having a plurality of time intervals, wherein the single chirp signal represents a radar return received from an object around a radar device; estimating a first phase difference between consecutive two of the subsignals when the object has a first velocity and estimating a second phase difference between consecutive two of the subsignals with the first velocity as reference when the object has a second velocity; and estimating a first estimated velocity according to a slope derived from the second phase difference.

### BRIEF DESCRIPTION OF THE DRAWINGS

The present disclosure can be more fully understood by reading the following detailed description of the embodiment, with reference made to the accompanying drawings as follows:

FIG. 1 shows is a schematic view of a velocity estimation method using Chinese Remainder Theorem (CRT) to prevent velocity ambiguity.

FIG. 2 shows a schematic view of a Doppler velocity estimation system using a single chirp signal according to a first embodiment of the present disclosure.

FIG. 3 shows a schematic view of a single chirp signal at a transmitter and a receiver in accordance with the first embodiment of the present disclosure.

FIG. 4 shows a flow chart of a Doppler velocity estimation method using a single chirp signal according to a second embodiment of the present disclosure.

FIG. 5A shows a schematic view of phase difference between samples in window [n:n+63] where n=1-60 and window [1:64] in a single chirp signal in accordance with an embodiment of the present disclosure.

FIG. 5B shows a partial enlarged view of the phase difference of FIG. 5A.

FIG. 6 shows a schematic view of phase difference between samples in window [n:n+63] where n=1-60 and window [1:64] in a single chirp signal with v=0 kph as reference in accordance with an embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

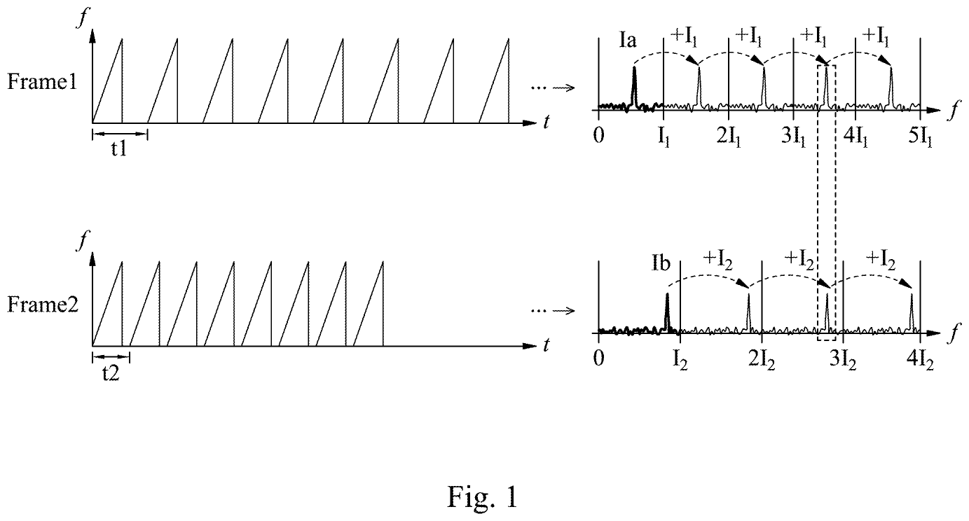

Reference is made to FIG. 1. FIG. 1 shows is a schematic view of a velocity estimation method using Chinese Remainder Theorem (CRT) to prevent velocity ambiguity. CRT is a method of solving the problem of ambiguous velocity. In this velocity estimation method, the transmission antenna transmits two sets of signals, so that the first set Frame1 of signals is transmitted first, and the second set Frame2 of signals is subsequently transmitted. Therein, the first set Frame1 of signals is formed of a plurality of sub-signals whose transmission cycle is defined as t1, and the second set Frame2 of signals is formed of a plurality of sub-signals whose transmission cycle is defined as t2. The transmission cycle t1 is different from the transmission cycle t2, and the resolution ranges of the velocity of the two sets of signals are also different. The horizontal axis in the time spectrum represents the time, and the vertical axis in the frequency spectrum represents the frequency. The horizontal axis in the frequency spectrum represents the frequency, and the vertical axis in the frequency spectrum represents the amplitude.

When the two sets of signals above are reflected by a target object, the receive antenna receives two sets of reflection signals, respectively, and then carries out a frequency domain analysis upon the two sets of reflection signals, thereby obtaining a frequency domain signal converted from the first set Frame1 of signals and another frequency domain signal converted from the second set Frame2 of signals. The resolvable Doppler frequency range of the first set Frame1 of signals is 11, and the resolved frequency is shown as Ia. However, due to the limitation of the Doppler frequency range, the actual frequency of the first set Frame1 of signals may be la+nl₁, where “n” is an integer larger than or equal to 0. The resolvable Doppler frequency range of the second set Frame2 of signals is 12, and the resolved frequency is shown as Ib, but the actual frequency of the second set Frame2 of signals is possibly Ib+ml₂, where “m” is an integer larger than or equal to 0. The frequency range I₁ and the frequency range I₂ respectively correspond to the transmission cycles of the first set Frame1 of signals and the second set Frame2 of signals. Therein, the numbers of chirps of the two sets of signals are identical, so that the numbers of the resolved Doppler bins are identical. However, the cycles of the two sets of transmission signals are different, so that the resolvable frequency range I₁ and the frequency range I₂ are also different. Therefore, after the frequency domain analysis process, the frequency Ia is different from the frequency Ib.

Based on the fact that the two sets of signals are the reflection of the same target object, the frequency of the first set Frame1 of signals will actually be identical to the frequency of the second set Frame2 of signals. In other words, the frequency Ia+nl₁ equals to the frequency Ib+mI₂. In order to obtain the correct velocity of the target object with respect to the antenna, the true frequency has to be obtained by calculating the common multiple of the solution of the two sets of signals.

However, because this velocity estimation method of solution finds the true velocity by matching the two sets of signals, when the environmental conditions are not ideal or the Signal-to-Noise Ratio (SNR) is unstable, the signals are easily lost, and the matching calculation is unable to be carried out. Besides, because multiple loop matching calculations are required according to the multiple of its expansion based on the resolvable Doppler frequency range and the resolved frequency of the two sets of signals, huge calculation resources are needed. Furthermore, the second set Frame2 of signals can only be transmitted after the first set Frame1 of signals has been transmitted, which is relatively time consuming.

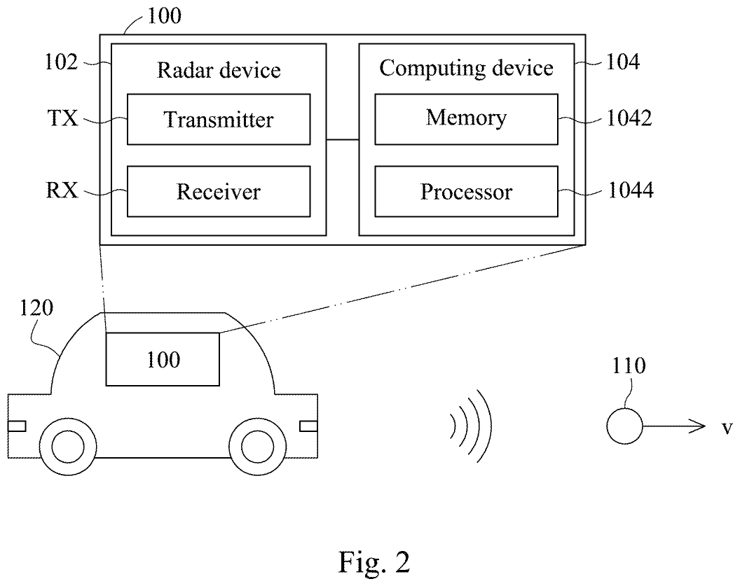

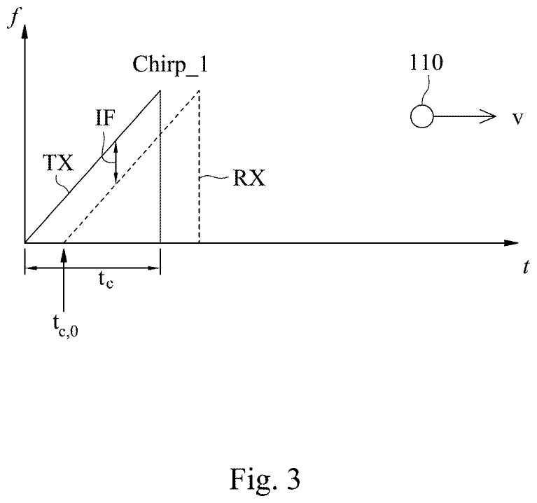

Reference is made to FIGS. 2 and 3. FIG. 2 shows a schematic view of a Doppler velocity estimation system 100 using a single chirp signal Chirp_1 according to a first embodiment of the present disclosure. FIG. 3 shows a schematic view of a single chirp signal Chirp_1 at a transmitter TX and a receiver RX in accordance with the first embodiment of the present disclosure. The Doppler velocity estimation system 100 using the single chirp signal Chirp_1 includes a radar device 102 and a computing device 104. The radar device 102 is configured to receive the single chirp signal Chirp_1 that represents a radar return RX received from an object 110 around the radar device 102. The radar device 102 includes at least one transmitter TX and at least one receiver RX. The object 110 has a velocity v relative to the radar device 102. The computing device 104 is signally connected to the radar device 102 and includes a memory 1042 and a processor 1044. The memory 1042 stores a Doppler velocity (v_{d}) of range-Doppler Fast Fourier Transform (FFT). The Doppler velocity (v_{d}) has the number (N) of flip. The processor 1044 is signally connected to the memory 1042 and configured to perform a Doppler velocity estimation method 200. The detail of the Doppler velocity estimation method 200 is described below.

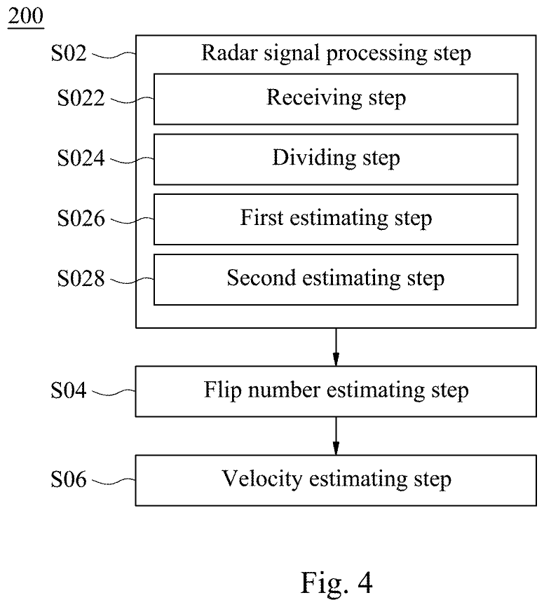

Reference is made to FIGS. 2-4. FIG. 4 shows a flow chart of a Doppler velocity estimation method 200 using a single chirp signal Chirp_1 according to a second embodiment of the present disclosure. The Doppler velocity estimation method 200 includes performing a radar signal processing step S02, a flip number estimating step S04 and a velocity estimating step S06.

The radar signal processing step S02 includes performing a receiving step S022, a dividing step S024, a first estimating step S026 and a second estimating step S028. The receiving step S022 includes configuring a radar device 102 to receive the single chirp signal Chirp_1 that represents a radar return RX received from an object 110 around the radar device 102. The dividing step S024 includes configuring a computing device 104 to divide the single chirp signal Chirp_1 into a plurality of subsignals having a plurality of time intervals. The first estimating step S026 includes configuring the computing device 104 to estimate a first phase difference between consecutive two of the subsignals when the object has a first velocity and estimate a second phase difference between consecutive two of the subsignals with the first velocity as reference when the object 110 has a second velocity. The second estimating step S028 includes configuring the computing device 104 to estimate a first estimated velocity (v_{c}) according to a slope derived from the second phase difference.

The flip number estimating step S04 is performed to configure the computing device 104 to estimate the number (N) of flip of a Doppler velocity (v_{d}) of range-Doppler FFT according to the first estimated velocity (v_{c}). The velocity estimating step S06 is performed to configure the computing device 104 to estimate a second estimated velocity (vₑₛₜ) according to the Doppler velocity (v_{d}) of range-Doppler FFT, the first estimated velocity (v_{c}) and the number (N) of flip.

In FIG. 3, the single chirp signal Chirp_1 has a ramp end time to and a sampling number Nₛ. The single chirp signal Chirp_1 has a time interval [t_{c,0}, t_{c,0}+t]. The time intervals of the subsignals have a same length (t_{c}/2) and different starting times. Considering the intermediate frequency (IF) signal of the single chirp signal Chirp_1, the first, second and last of the subsignals may be described as follows:

$${s}_{1} ( t ) = A sin ( 2 π {f}_{1} t + {ϕ}_{1} ) . \qquad ( 1 )$$

$${s}_{2} ( t ) = A sin ( 2 π {f}_{2} t + {ϕ}_{2} ) . \qquad ( 2 )$$

$${s}_{{N}_{s} / 2} ( t ) = A sin ( 2 π {f}_{{N}_{s} / 2} t + {ϕ}_{{N}_{s} / 2} ) . \qquad ( 3 )$$

$${f}_{1} \approx {f}_{2} \approx {f}_{{N}_{s} / 2} . \qquad ( 4 )$$

$${ϕ}_{1} \neq {ϕ}_{2} \neq {ϕ}_{{N}_{s} / 2} . \qquad ( 5 )$$

The time intervals of the first, second and last of the subsignals may be represented as

$$[ {t}_{c , 0} , {t}_{c , 0} + \frac{{t}_{c}}{2} ] ,$$

$$[ {t}_{c , 0} + \frac{{t}_{c}}{{N}_{s}} , {t}_{c , 0} + \frac{{t}_{c}}{{N}_{s}} + \frac{{t}_{c}}{2} ]$$

$$and$$

$$[ {t}_{c , 0} + \frac{{t}_{c}}{2} , {t}_{c , 0} + \frac{{t}_{c}}{2} + \frac{{t}_{c}}{2} ] .$$

The rest can be deduced by analogy. The first phase difference Δϕ may be described as follows:

$$Δ ϕ = {ϕ}_{j + 1} - {ϕ}_{j} = \frac{4 π}{λ} Δ {d}_{j , j + 1} = \frac{4 π v}{λ} \frac{{t}_{c}}{{N}_{s}} . \qquad ( 6 )$$

“j” is a positive integer. “ϕ” represents a phase of one of the subsignals. The first phase difference Δϕ is positively correlated with (proportional to) the first estimated velocity (v_{c}) and the ramp end time t_{c}, and the first phase difference Δϕ is negatively correlated with (inversely proportional to) the sampling number Nₛ. “Δd_{i,j+1}” represents a distance traveled by the object 110 during a time period of t_{c}/Nₛ when the object 110 has the velocity v. In one embodiment, the sampling number Nₛ of the subsignals (samples) in the single chirp signal Chirp_1 is 128, but the present disclosure is not limited thereto.

In the flip number estimating step S04, the number (N) of flip of the Doppler velocity (v_{d}) of range-Doppler FFT is estimated by the computing device 104 according to the first estimated velocity (v_{c}) and a maximum unambiguous velocity (vₘₐₓ). The maximum unambiguous velocity (vₘₐₓ) is defined by a wavelength and a chirp period of the single chirp signal Chirp_1. The wavelength is represented as λ, and the chirp period is represented as chirp_period. The maximum unambiguous velocity is represented as vₘₐₓ and described as follows:

$${v}_{max} = \frac{λ}{4 * chirp\_period} . \qquad ( 7 )$$

The first estimated velocity is represented as v_{c}. There are two conditions for the first estimated velocity v_{c}. One is for the first estimated velocity that is greater than or equal to 0 (i.e., v_{c}>0 or v_{c}=0), and the other is for the first estimated velocity that is smaller than 0 (i.e., v_{c}<0). The Doppler velocity is represented as v_{d}, and the number of flip is represented as N. The second estimated velocity is represented as vₑₛₜ.

For v_{c}>0 or v_{c}=0, the number N of flip is described as follows: in response to determining that v_{c}<vₘₐₓ and |v_{c}−v_{d}|<vₘₐₓ, the number N of flip is equal to 0; in response to determining that v_{c}<vₘₐₓ and |v_{c}−v_{d}|>vₘₐₓ, the number N of flip is equal to 1; and in response to determining that v_{c}>vₘₐₓ, the number N of flip is described as follows:

$$N = fix ( \frac{{v}_{c} - {v}_{max}}{2 {v}_{max}} ) + 1 . \qquad ( 8 )$$

“fix” represents taking integer. In the velocity estimating step S06, the second estimated velocity is described as follows:

$${v}_{est} = {v}_{d} + 2 {Nv}_{max} . \qquad ( 9 )$$

For v_{c}<0, the number N of flip is described as follows: in response to determining that v_{c}>−vₘₐₓ and |v_{c}−v_{d}|<vₘₐₓ, the number N of flip is equal to 0; in response to determining that v_{c}>−vₘₐₓ and |v_{c}−v_{d}|>vₘₐₓ, the number N of flip is equal to 1; and in response to determining that v_{c}<−vₘₐₓ, the number N of flip is described as follows:

$$N = - fix ( \frac{{v}_{c} + {v}_{max}}{2 {v}_{max}} ) + 1 . \qquad ( 10 )$$

In the velocity estimating step S06, the second estimated velocity is described as follows:

$${v}_{est} = {v}_{d} - 2 {Nv}_{max} . \qquad ( 11 )$$

Therefore, the Doppler velocity estimation system 100 and the Doppler velocity estimation method 200 of the present disclosure can only utilize the single chirp signal Chirp_1 to obtain the first phase difference between samples in different windows and the first window and the second phase difference between samples in different windows and the first window with v=0 kph as reference to roughly estimate the first estimated velocity v_{c} of the object 110. Then, the present disclosure can compare the first estimated velocity v_{c} with the maximum unambiguous velocity vₘₐₓ and the Doppler velocity v_{d} of range-Doppler FFT to estimate the number N of flip of the Doppler velocity v_{d} of range-Doppler FFT, thus correctly estimating the second estimated velocity vₑₛₜ of the object 110. Compared to the conventional velocity estimation method using CRT, the present disclosure can save computing resources and obtain more accurate velocity.

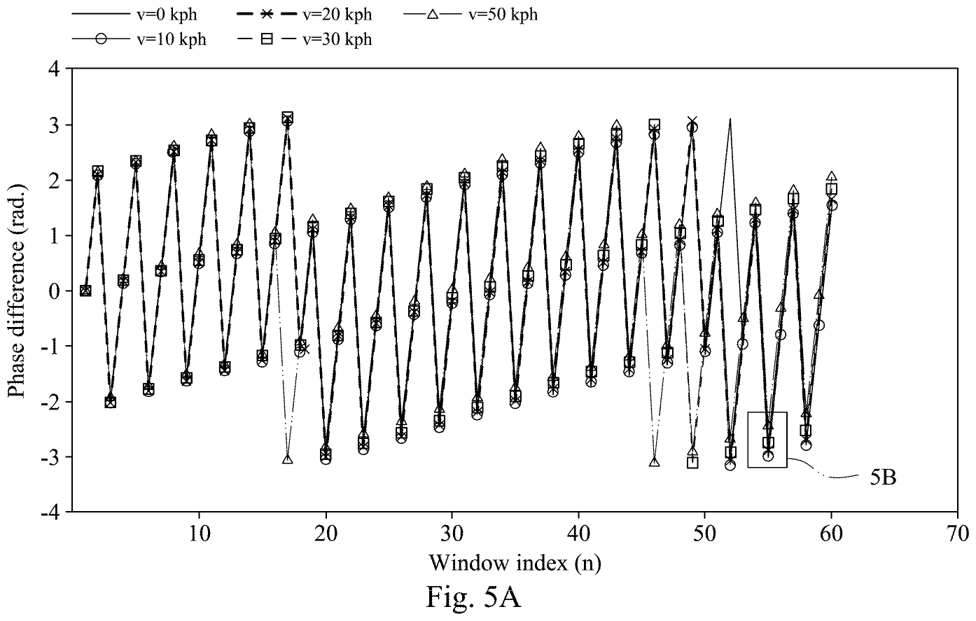

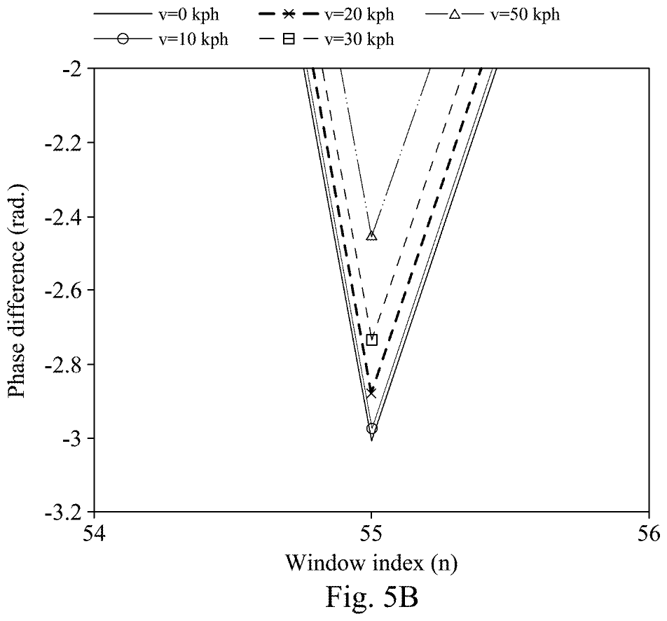

Reference is made to FIGS. 2, 5A and 5B. FIG. 5A shows a schematic view of phase difference between samples in window [n:n+63] where n=1-60 and window [1:64] in a single chirp signal Chirp_1 in accordance with an embodiment of the present disclosure. FIG. 5B shows a partial enlarged view of the phase difference of FIG. 5A. In FIGS. 5A and 5B, the Doppler velocity estimation system 100 using the single chirp signal Chirp_1 utilizes the structure of 1TX-3RX (the structure of one transmitter and three receivers), and the simulated target is located at R=15 m (i.e., the distance between the radar device 102 and the object 110 is 15 m). The radar device 102 includes a Frequency Modulated Continuous Wave (FMCW) radar. “n” represents a window index which is a positive value. In FMCW and the single chirp signal Chirp_1, the ramp end time t_{c} is 34 us, and the sampling number Nₛ is 128. The wavelength λ is 0.0039 m, and the chirp period chirp_period is 200 us. The chirp number Nc in a frame is 128. The active frame time and the velocity resolution Δv of FMCW may be described as follows:

$$Active frame time = chirp\_period * Nc = ( 200 us ) * 25.6 ms . \qquad ( 12 )$$

$$Δ v = \frac{λ}{2 * ( active frame time )} = \frac{0.0039 m}{2 * ( 0.0256 s )} = 0.0762 m / s . \qquad ( 13$$

In addition, the maximum unambiguous velocity vₘₐₓ may be described as follows:

$${v}_{max} = \frac{λ}{4 * chirp\_period} = \frac{0.0039 m}{4 * 200 * {10}^{- 6} s} = 4.8 \; 75 m / s . \qquad ( 14 )$$

In FIGS. 5A and 5B, it can be known that the phase difference between each window and the first window is estimated at a velocity v (e.g., v=0 kph, 10 kph, 20 kph, 30 kph or 50 kph). In other words, the first phase difference between consecutive two of the subsignals when the object 110 has the first velocity (e.g., v=0 kph) can be estimated according to the first estimating step S026 of the present disclosure.

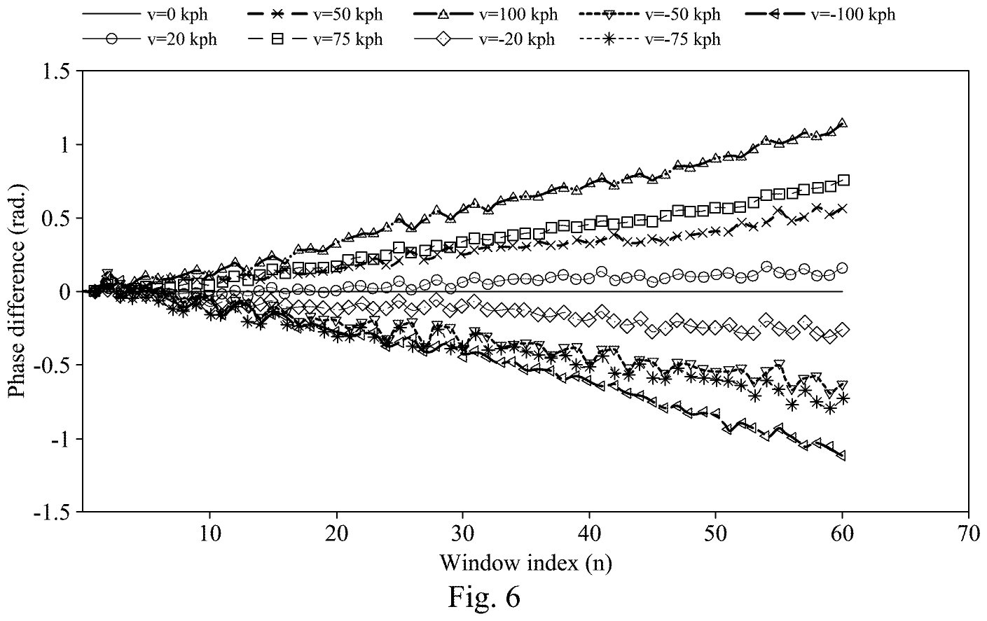

Reference is made to FIGS. 2, 5A, 5B and 6. FIG. 6 shows a schematic view of phase difference between samples in window [n:n+63] where n=1-60 and window [1:64] in a single chirp signal Chirp_1 with v=0 kph as reference in accordance with an embodiment of the present disclosure. The slope of the phase difference and the estimated velocity v of FMCW may be described as follows:

$$Slope = \frac{4 π v}{λ} * \frac{{t}_{c}}{{N}_{s}} . \qquad ( 15 )$$

$$v = \frac{λ * {N}_{s} * Slope}{4 π {t}_{c}} . \qquad ( 16 )$$

In FIG. 6, it can be known that the phase difference between each of different velocities (e.g., v=0 kph, 20 kph, 50 kph, 75 kph, 100 kph, −20 kph, −50 kph, −75 kph, −100 kph) and a first velocity (e.g., v=0 kph) is estimated. In other words, the second phase difference between consecutive two of the subsignals with the first velocity as reference when the object 110 has a second velocity (i.e., one of the different velocities) can be estimated according to the first estimating step S026 of the present disclosure. Moreover, the first estimated velocity v_{c} (i.e., the estimated velocity v in equation (16)) can be estimated according to the slope derived from the second phase difference. For example, the slope may be derived from a linear relationship of the phase differences between one of the different velocities and the first velocity with n=1-60.

Table 1 lists examples of the Doppler velocity v_{d}, the first estimated velocity v_{c}, the number N of flip and the second estimated velocity vₑₛₜ when the true velocity v of the object 110 is positive. Table 2 lists examples of the Doppler velocity v_{d}, the first estimated velocity v_{c}, the number N of flip and the second estimated velocity vₑₛₜ when the true velocity v of the object 110 is negative. The true velocities v of ±2.78 m/s, 5.56 m/s, ±8.33 m/s, +11.11 m/s, ±13.89 m/s, ±20.83 m/s, ±27.78 m/s and ±34.72 correspond to ±10 kph, ±20 kph, ±30 kph, ±40 kph, ±50 kph, ±75 kph, ±100 kph and ±125 kph, respectively. In Tables 1 and 2, it is obvious that the present disclosure can estimate the number N of flip of the Doppler velocity v_{d} of range-Doppler FFT by comparing the first estimated velocity v_{c} with the maximum unambiguous velocity vₘₐₓ and the Doppler velocity v_{d}, thus correctly estimating the second estimated velocity vₑₛₜ of the object 110.

TABLE 1

| | | | | | | | | |
|---|---|---|---|---|---|---|---|---|
| v | 2.78 | 5.56 | 8.33 | 11.11 | 13.89 | 20.83 | 27.78 | 34.72 |
| (m/s) | | | | | | | | |
| v_{d} | 2.82 | −4.19 | −1.37 | 1.45 | 4.19 | 1.45 | −1.37 | −4.11 |
| v_{c} | 1.92 | 3.42 | 7.39 | 8.07 | 12.73 | 17.65 | 26.41 | 35.44 |
| N | 0 | 1 | 1 | 1 | 1 | 2 | 3 | 4 |
| vₑₛₜ | 2.82 | 5.56 | 8.38 | 11.2 | 13.94 | 20.95 | 27.88 | 34.89 |

TABLE 2

| | | | | | | | | |
|---|---|---|---|---|---|---|---|---|
| v | −2.78 | −5.56 | −8.33 | −11.11 | −13.89 | −20.83 | −27.78 | −34.72 |
| (m/s) | | | | | | | | |
| v_{d} | −2.82 | 4.19 | 1.37 | −1.45 | −4.19 | −1.45 | 1.37 | 4.11 |
| v_{c} | −4.65 | −6.98 | −8.07 | −12.73 | −13.68 | −16.97 | −25.73 | −34.76 |
| N | 0 | 1 | 1 | 1 | 1 | 2 | 3 | 4 |
| vₑₛₜ | −2.82 | −5.56 | −8.38 | −11.2 | −13.94 | −20.95 | −27.88 | −34.89 |

In the present disclosure, the first estimated velocity v_{c} or the second estimated velocity vₑₛₜ can be configured to control a vehicle 120, but the present disclosure is not limited thereto. The radar device 102 and the computing device 104 are disposed on the vehicle 120. The Doppler velocity estimation method 200 using the single chirp signal Chirp_1 further includes controlling motion of the vehicle 120 by a steering system, a propulsion system or a braking system according to the second estimated velocity vₑₛₜ.

In one embodiment, the present disclosure can be applied to a radar scenario of a Blind Spot Detection (BSD). For one example, in the radar scenario of the BSD, assuming that the vehicle 120 wants to travel from a current lane to a right lane, there is another vehicle approaching quickly from behind the right lane at the same time. If the computing device 104 incorrectly estimates the velocity of the object 110 (i.e., the another vehicle), the computing device 104 may estimate that the velocity of the another vehicle is not very fast and judge that it is not dangerous for the vehicle 120 to switch to the right lane at this time, so that no warning signal is issued. If the vehicle 120 switches to the right lane at this time, an accident may be occurred between the vehicle 120 and the another vehicle coming from behind due to the failure to react in time. However, if the computing device 104 performs the Doppler velocity estimation method 200 using the single chirp signal Chirp_1 of the present disclosure to obtain a correct estimated velocity (i.e., the second estimated velocity vₑₛₜ), motion of the vehicle 120 can be controlled by the second estimated velocity vₑₛₜ to return to the original lane (i.e., the current lane), thereby achieving autonomous driving and increasing safety.

In addition, in the Time Division Modulation (TDM) Multi Input Multi Output (MIMO) technology commonly used in the FMCW radar, different transmitting antennas transmit at different times. When the object 110 moves with Doppler velocity, a phase difference between the different transmitting antennas will be generated, and the phase difference is linearly proportional to the velocity of the object 110. Therefore, phase compensation of the Doppler velocity between different transmitting antennas needs to be performed to make sure that the antenna phase is correct. The object angle estimated by the radar device is obtained by using the principle related to the phase differences and angles when receiving electromagnetic wave signals in different antennas. The object angle is correctly estimated only when the antenna phase is correct.

For another example, in the radar scenario of the BSD, assuming that the vehicle 120 wants to travel from a current lane to an adjacent right lane, there is another vehicle approaching from behind the adjacent right lane at the same time. If the computing device 104 incorrectly estimates the velocity of the object 110 (i.e., the another vehicle), it may also cause the deviation error of estimating the object angle. If the computing device 104 incorrectly estimates that the another vehicle is located in a second right lane, the computing device 104 judges that it is not dangerous for the vehicle 120 to switch to the adjacent right lane at this time, so that no warning signal is issued. The second right lane represents a lane at the right of the first right lane (i.e., the adjacent right lane). If the vehicle 120 switches to the adjacent right lane at this time, an accident may be occurred between the vehicle 120 and the another vehicle coming from behind due to the failure to react in time. However, if the computing device 104 performs the Doppler velocity estimation method 200 using the single chirp signal Chirp_1 of the present disclosure to obtain a correct estimated velocity (i.e., the second estimated velocity vₑₛₜ), the correct object angle of the another vehicle can also be obtained, and motion of the vehicle 120 can be controlled by the second estimated velocity vₑₛₜ to return to the original lane (i.e., the current lane), thereby achieving autonomous driving and increasing safety.

In one embodiment, the present disclosure can be applied to a radar scenario of an Adaptive Cruise Control (ACC) system. The ACC system is an advanced cruise control assisted driving system. The ACC system disposed on the vehicle 120 can automatically adjust the velocity of the vehicle 120 to maintain a safe distance from a front vehicle. If the front vehicle is detected ahead of the vehicle 120, the ACC system can reduce or increase the velocity of the vehicle 120 based on demand to maintain a selected following distance at a predetermined velocity. When the ACC system disposed on the vehicle 120 is turned on, if the front vehicle suddenly accelerates or decelerates, and the velocity of the front vehicle relative to the vehicle 120 exceeds a range of the maximum unambiguous velocity detected by the radar device, the computing device 104 may misjudge the velocity of the front vehicle to suddenly increase or decrease the velocity of the vehicle 120, and then an accident may be occurred. However, if the computing device 104 performs the Doppler velocity estimation method 200 using the single chirp signal Chirp_1 of the present disclosure to obtain a correct estimated velocity (i.e., the second estimated velocity vₑₛₜ), the velocity of the vehicle 120 can be controlled by the second estimated velocity vₑₛₜ to maintain the safe distance from the front vehicle, thereby achieving autonomous driving and increasing safety.

It is understood that one of the Doppler velocity estimation method 200 of the present disclosure is performed by the aforementioned steps. A computer program of the present disclosure stored on a non-transitory tangible computer readable recording medium is used to perform the method described above. The aforementioned embodiments can be provided as a computer program product, which may include a machine-readable medium on which instructions are stored for programming a computer (or other electronic devices) to perform a process based on the embodiments of the present disclosure. The machine-readable medium can be, but is not limited to, a floppy diskette, an optical disk, a Compact Disk Read-Only Memory (CD-ROM), a magneto-optical disk, a Read-Only Memory (ROM), a Random Access Memory (RAM), an Erasable Programmable Read-Only Memory (EPROM), an Electrically Erasable Programmable Read-Only Memory (EEPROM), a magnetic or optical card, a flash memory, or another type of media/machine-readable medium suitable for storing electronic instructions. Moreover, the embodiments of the present disclosure also can be downloaded as a computer program product, which may be transferred from a remote computer to a requesting computer by using data signals via a communication link (such as a network connection or the like). In addition, the present disclosure provides a non-transitory storage medium having instructions therein, when executed, causing the processor 1044 to perform the Doppler velocity estimation method 200 using the single chirp signal Chirp_1, as exemplified in one of the embodiments. In an embodiment, a storage medium, such as non-transitory storage medium, stores computer-readable instructions (or program code), and the instructions are executed on at least one computing device, such that the at least one computing device carries out a method according to at least one of the embodiments.

According to the aforementioned embodiments and examples, the advantages of the present disclosure are described as follows.

1. The Doppler velocity estimation system and the Doppler velocity estimation method of the present disclosure only utilize the single chirp signal instead of using two different chirps to obtain the first phase difference between samples in different windows and the first window and the second phase difference between samples in different windows and the first window with v=0 kph as reference, thereby roughly estimating the first estimated velocity of the object.

2. The Doppler velocity estimation system and the Doppler velocity estimation method of the present disclosure compare the first estimated velocity with the maximum unambiguous velocity and the Doppler velocity of range-Doppler FFT to estimate the number of flip of the Doppler velocity of range-Doppler FFT, thus correctly estimating the second estimated velocity of the object. Compared to the conventional velocity estimation method using CRT, the present disclosure can save computing resources and obtain more accurate velocity.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A Doppler velocity estimation method using a single chirp signal, comprising:
performing a radar signal processing step, wherein the radar signal processing step comprises:
configuring a radar device to receive the single chirp signal that represents a radar return received from an object around the radar device;
configuring a computing device to divide the single chirp signal into a plurality of subsignals having a plurality of time intervals;
configuring the computing device to estimate a first phase difference between consecutive two of the subsignals when the object has a first velocity and estimate a second phase difference between consecutive two of the subsignals with the first velocity as reference when the object has a second velocity; and
configuring the computing device to estimate a first estimated velocity according to a slope derived from the second phase difference.

2. The Doppler velocity estimation method using the single chirp signal of claim 1, further comprising:
performing a flip number estimating step to configure the computing device to estimate a number of flip of a Doppler velocity of range-Doppler Fast Fourier Transform (FFT) according to the first estimated velocity; and
performing a velocity estimating step to configure the computing device to estimate a second estimated velocity according to the Doppler velocity of range-Doppler FFT, the first estimated velocity and the number of flip;
wherein the second estimated velocity is configured to control a vehicle.

3. The Doppler velocity estimation method using the single chirp signal of claim 2, wherein the radar device and the computing device are disposed on the vehicle, and the Doppler velocity estimation method further comprises:
controlling motion of the vehicle by a steering system, a propulsion system or a braking system according to the second estimated velocity;
wherein the radar device comprises a Frequency Modulated Continuous Wave (FMCW) radar.

4. The Doppler velocity estimation method using the single chirp signal of claim 1, wherein the single chirp signal has a ramp end time and a sampling number, the time intervals of the subsignals have a same length and different starting times, the first phase difference is positively correlated with the first estimated velocity and the ramp end time, and the first phase difference is negatively correlated with the sampling number.

5. The Doppler velocity estimation method using the single chirp signal of claim 2, wherein in the flip number estimating step, the number of flip of the Doppler velocity of range-Doppler FFT is estimated by the computing device according to the first estimated velocity and a maximum unambiguous velocity;
wherein the maximum unambiguous velocity is defined by a wavelength and a chirp period of the single chirp signal.

6. The Doppler velocity estimation method using the single chirp signal of claim 5, wherein in the flip number estimating step, the first estimated velocity is represented as v_{c} and greater than or equal to 0, the maximum unambiguous velocity is represented as vₘₐₓ, the Doppler velocity is represented as v_{d}, and the number of flip is represented as N and described as follows:
in response to determining that v_{c}<vₘₐₓ and |v_{c}−v_{d}|<vₘₐₓ, the number of flip is equal to 0;
in response to determining that v_{c}<vₘₐₓ and |v_{c}−v_{d}|>vₘₐₓ, the number of flip is equal to 1; and
in response to determining that v_{c}>vₘₐₓ, the number of flip is described as follows:
$$N = fix ( \frac{{v}_{c} - {v}_{max}}{2 {v}_{max}} ) + 1 ;$$
wherein fix represents taking integer.

7. The Doppler velocity estimation method using the single chirp signal of claim 6, wherein in the velocity estimating step, the second estimated velocity is represented as vₑₛₜ and described as follows:
$${v}_{est} = {v}_{d} + 2 {Nv}_{max} .$$

8. The Doppler velocity estimation method using the single chirp signal of claim 5, wherein in the flip number estimating step, the first estimated velocity is represented as v_{c} and smaller than 0, the maximum unambiguous velocity is represented as vₘₐₓ, the Doppler velocity is represented as v_{d}, and the number of flip is represented as N and described as follows:
in response to determining that v_{c}>−vₘₐₓ and |v_{c}−v_{d}|<vₘₐₓ, the number of flip is equal to 0;
in response to determining that v_{c}>−vₘₐₓ and |v_{c}−v_{d}|>vₘₐₓ, the number of flip is equal to 1; and
in response to determining that v_{c}<−vₘₐₓ, the number of flip is described as follows:
$$N = - fix ( \frac{{v}_{c} + {v}_{max}}{2 {v}_{max}} ) + 1 ;$$
wherein fix represents taking integer.

9. The Doppler velocity estimation method using the single chirp signal of claim 8, wherein in the velocity estimating step, the second estimated velocity is represented as vₑₛₜ and described as follows:
$${v}_{est} = {v}_{d} - 2 {Nv}_{max} .$$

10. A Doppler velocity estimation system using a single chirp signal, comprising:
a radar device configured to receive the single chirp signal that represents a radar return received from an object around the radar device; and
a computing device signally connected to the radar device and comprising:
a memory storing a Doppler velocity of range-Doppler Fast Fourier Transform (FFT), wherein the Doppler velocity has a number of flip; and
a processor signally connected to the memory and configured to perform a Doppler velocity estimation method;
wherein the Doppler velocity estimation method comprises:
performing a radar signal processing step, wherein the radar signal processing step comprises:
dividing the single chirp signal into a plurality of subsignals having a plurality of time intervals;
estimating a first phase difference between consecutive two of the subsignals when the object has a first velocity and estimating a second phase difference between consecutive two of the subsignals with the first velocity as reference when the object has a second velocity; and
estimating a first estimated velocity according to a slope derived from the second phase difference.

11. The Doppler velocity estimation system using the single chirp signal of claim 10, wherein the Doppler velocity estimation method further comprises:
performing a flip number estimating step to estimate the number of flip of the Doppler velocity of range-Doppler FFT according to the first estimated velocity; and
performing a velocity estimating step to estimate a second estimated velocity according to the Doppler velocity of range-Doppler FFT, the first estimated velocity and the number of flip;
wherein the second estimated velocity is configured to control a vehicle.

12. The Doppler velocity estimation system using the single chirp signal of claim 11, wherein the radar device and the computing device are disposed on the vehicle, and the Doppler velocity estimation method further comprises:
controlling motion of the vehicle by a steering system, a propulsion system or a braking system according to the second estimated velocity;
wherein the radar device comprises a Frequency Modulated Continuous Wave (FMCW) radar.

13. The Doppler velocity estimation system using the single chirp signal of claim 10, wherein the single chirp signal has a ramp end time and a sampling number, the time intervals of the subsignals have a same length and different starting times, the first phase difference is positively correlated with the first estimated velocity and the ramp end time, and the first phase difference is negatively correlated with the sampling number.

14. The Doppler velocity estimation system using the single chirp signal of claim 11, wherein in the flip number estimating step, the number of flip of the Doppler velocity of range-Doppler FFT is estimated by the computing device according to the first estimated velocity and a maximum unambiguous velocity;
wherein the maximum unambiguous velocity is defined by a wavelength and a chirp period of the single chirp signal.

15. The Doppler velocity estimation system using the single chirp signal of claim 14, wherein in the flip number estimating step, the first estimated velocity is represented as v_{c} and greater than or equal to 0, the maximum unambiguous velocity is represented as vₘₐₓ, the Doppler velocity is represented as v_{d}, and the number of flip is represented as N and described as follows:
in response to determining that v_{c}<vₘₐₓ and |v_{c}−v_{d}|<vₘₐₓ, the number of flip is equal to 0;
in response to determining that v_{c}<vₘₐₓ and |v_{c}−v_{d}|>vₘₐₓ, the number of flip is equal to 1; and
in response to determining that v_{c}>vₘₐₓ, the number of flip is described as follows:
$$N = fix ( \frac{{v}_{c} - {v}_{max}}{2 {v}_{max}} ) + 1 ;$$
wherein fix represents taking integer.

16. The Doppler velocity estimation system using the single chirp signal of claim 15, wherein in the velocity estimating step, the second estimated velocity is represented as vₑₛₜ and described as follows:
$${v}_{est} = {v}_{d} + 2 {Nv}_{max} .$$

17. The Doppler velocity estimation system using the single chirp signal of claim 14, wherein in the flip number estimating step, the first estimated velocity is represented as v_{c} and smaller than 0, the maximum unambiguous velocity is represented as vₘₐₓ, the Doppler velocity is represented as v_{d}, and the number of flip is represented as N and described as follows:
in response to determining that v_{c}>−vₘₐₓ and |v_{c}−v_{d}|<vₘₙₐₓ, the number of flip is equal to 0;
in response to determining that v_{c}>−vₘₐₓ and |v_{c}−v_{d}|>vₘₐₓ, the number of flip is equal to 1; and
in response to determining that v_{c}<−vₘₐₓ, the number of flip is described as follows:
$$N = - fix ( \frac{{v}_{c} + {v}_{max}}{2 {v}_{max}} ) + 1 ;$$
wherein fix represents taking integer.

18. The Doppler velocity estimation system using the single chirp signal of claim 17, wherein in the velocity estimating step, the second estimated velocity is represented as vₑₛₜ and described as follows:
$${v}_{est} = {v}_{d} - 2 {Nv}_{max} .$$

19. A non-transitory storage medium having instructions therein, when executed, causing a processor to perform a Doppler velocity estimation method using a single chirp signal, and the Doppler velocity estimation method comprising:
performing a radar signal processing step, wherein the radar signal processing step comprises:
dividing the single chirp signal into a plurality of subsignals having a plurality of time intervals, wherein the single chirp signal represents a radar return received from an object around a radar device;
estimating a first phase difference between consecutive two of the subsignals when the object has a first velocity and estimating a second phase difference between consecutive two of the subsignals with the first velocity as reference when the object has a second velocity; and
estimating a first estimated velocity according to a slope derived from the second phase difference.

20. The non-transitory storage medium of claim 19, wherein the Doppler velocity estimation method further comprises:
performing a flip number estimating step to estimate a number of flip of a Doppler velocity of range-Doppler Fast Fourier Transform (FFT) according to the first estimated velocity; and
performing a velocity estimating step to estimate a second estimated velocity according to the Doppler velocity of range-Doppler FFT, the first estimated velocity and the number of flip;
wherein the second estimated velocity is configured to control a vehicle.

21. The non-transitory storage medium of claim 20, wherein,
the single chirp signal has a ramp end time and a sampling number, the time intervals of the subsignals have a same length and different starting times, the first phase difference is positively correlated with the first estimated velocity and the ramp end time, and the first phase difference is negatively correlated with the sampling number; and
in the flip number estimating step, the number of flip of the Doppler velocity of range-Doppler FFT is estimated according to the first estimated velocity and a maximum unambiguous velocity, and the maximum unambiguous velocity is defined by a wavelength and a chirp period of the single chirp signal.

22. The non-transitory storage medium of claim 21, wherein in the flip number estimating step, the first estimated velocity is represented as v_{c} and greater than or equal to 0, the maximum unambiguous velocity is represented as vₘₐₓ, the Doppler velocity is represented as v_{d}, and the number of flip is represented as N and described as follows:
in response to determining that v_{c}<vₘₐₓ and |v_{c}−v_{d}|<vₘₐₓ, the number of flip is equal to 0;
in response to determining that v_{c}<vₘₐₓ and |v_{c}−v_{d}|>vₘₐₓ, the number of flip is equal to 1; and
in response to determining that v_{c}>vₘₐₓ, the number of flip is described as follows:
$$N = fix ( \frac{{v}_{c} - {v}_{max}}{2 {v}_{max}} ) + 1 ;$$
wherein fix represents taking integer;
wherein in the velocity estimating step, the second estimated velocity is represented as vₑₛₜ and described as follows:
$${v}_{est} = {v}_{d} + 2 {Nv}_{max} .$$

23. The non-transitory storage medium of claim 21, wherein in the flip number estimating step, the first estimated velocity is represented as v_{c} and smaller than 0, the maximum unambiguous velocity is represented as vₘₐₓ, the Doppler velocity is represented as v_{d}, and the number of flip is represented as N and described as follows:
in response to determining that v_{c}>−vₘₐₓ and |v_{c}−v_{d}|<vₘₐₓ, the number of flip is equal to 0;
in response to determining that v_{c}>−vₘₐₓ and |v_{c}−v_{d}|>vₘₐₓ, the number of flip is equal to 1; and
in response to determining that v_{c}<−vₘₐₓ, the number of flip is described as follows:
$$N = - fix ( \frac{{v}_{c} + {v}_{max}}{2 {v}_{max}} ) + 1 ;$$
wherein fix represents taking integer;
wherein in the velocity estimating step, the second estimated velocity is represented as vₑₛₜ and described as follows:
$${v}_{est} = {v}_{d} - 2 {Nv}_{max} .$$
